(19) United States
(12) Patent Application Publication
(10) Pub. No.: US 2024/0136639 A1
(43) Pub. Date: Apr. 25, 2024

(54) BATTERY MODULE

(71) Applicant: Prime Planet Energy & Solutions, Inc., Tokyo (JP)

(72) Inventors: Shota HIROHATA, Kasai-shi (JP); Iwao TANAKA, Osaka (JP); Kosyo ABE, Himeji-shi (JP); Yoshiko DAIJO, Himeji-shi (JP); Tomochika TERANAKA, Osaka (JP)

(21) Appl. No.: 18/490,701

(22) Filed: Oct. 18, 2023

(30) Foreign Application Priority Data
Oct. 19, 2022 (JP) 2022-168083

(51) Int. Cl. H01M 50/264; H01M 50/209; H01M 50/271

(52) U.S. Cl. CPC H01M 50/264; H01M 50/209; H01M 50/271

(57) ABSTRACT

A battery module includes: a plurality of stacked battery cells; a first cover body and a second cover body provided to cover the plurality of battery cells in a direction orthogonal to a stacking direction of the battery cells; a pair of binding bars that restrain the plurality of battery cells in the stacking direction of the battery cells; and a retainer connected to each of the binding bars. The first cover body has a first overlapping portion. The second cover body has a second overlapping portion disposed between each of the battery cells and the first overlapping portion and overlapping with the first overlapping portion in a direction orthogonal to the stacking direction of the battery cells. The first cover body is disposed between each of the battery cells and the retainer in the direction orthogonal to the stacking direction of the battery cells.

### CROSS REFERENCE TO RELATED APPLICATIONS

This nonprovisional application is based on Japanese Patent Application No. 2022-168083 filed on Oct. 20, 2022 with the Japan Patent Office, the entire contents of which are hereby incorporated by reference.

### BACKGROUND OF THE INVENTION

### Field of the Invention

The present invention relates to a battery module.

### Description of the Background Art

For example, Japanese Patent Laying-Open No. 2018-181562 discloses a battery wiring module including: a first divided housing and a second divided housing each attached to an upper portion of a secondary battery; a first cover and a second cover that respectively cover openings of the first divided housing and the second divided housing; and a tongue piece portion extending from the first cover toward the second cover.

### SUMMARY OF THE INVENTION

As disclosed in Japanese Patent Laying-Open No. 2018-181562, there has been known a battery module including: a plurality of battery cells (secondary batteries); and a plurality of cover bodies (first cover and second cover) provided to cover the plurality of battery cells.

In such a battery module, when a temperature of a case body is changed due to a temperature change of a battery cell, the cover body is expanded or contracted in accordance with its linear expansion coefficient. In this case, a positional relation between the cover bodies is compromised, with the result that an insulation distance for each battery cell may not be sufficiently secured. Also, it is required to prevent the cover body from falling off due to the expansion and contraction of the cover body.

Thus, it is an object of the present invention to solve the above-described problem and to provide a battery module to prevent a cover body from falling off while securing a sufficient insulation distance for each battery cell by the cover body.

[1] A battery module comprising: a plurality of battery cells stacked in a first direction; a first cover body and a second cover body arranged side by side in the first direction and provided to cover the plurality of battery cells in a second direction orthogonal to the first direction; an attachment-target member to which the first cover body and the second cover body are attached; a pair of binding bars extending, in the first direction, on both sides beside the plurality of battery cells in a third direction orthogonal to the first direction and the second direction, the pair of binding bars restraining the plurality of battery cells in the first direction; and a retainer extending in the third direction and connected to the pair of binding bars, wherein the first cover body has a first overlapping portion, the second cover body has a second overlapping portion disposed between each of the battery cells and the first overlapping portion and overlapping with the first overlapping portion in the second direction, and the first cover body is disposed between each of the battery cells and the retainer in the second direction.

According to the battery module thus configured, in response to expansion and contraction of each of the first cover body and the second cover body due to a temperature change, the first overlapping portion and the second overlapping portion are slid in the first direction with the first overlapping portion and the second overlapping portion overlapping with each other. Thus, a clearance can be prevented from being formed between the first cover body and the second cover body, thereby sufficiently securing an insulation distance for each battery cell. In this case, since the second overlapping portion is disposed between each battery cell and the first overlapping portion in the second direction and the first cover body is disposed between each battery cell and the retainer in the second direction, the first cover body can prevent the second cover body from falling off and the retainer can prevent the first cover body from falling off.

[2] The battery module according to [1], wherein the first cover body has a first connection portion disposed opposite to the second cover body with respect to the first overlapping portion in the first direction, the first connection portion being connected to the attachment-target member so as to be fixed in the first direction, the second cover body has a second connection portion disposed opposite to the first cover body with respect to the second overlapping portion in the first direction, the second connection portion being connected to the attachment-target member so as to be fixed in the first direction, and at least one of the first cover body and the second cover body further has a third connection portion disposed between the first connection portion and the second connection portion in the first direction, the third connection portion being connected to the attachment-target member so as to be slidable in the first direction.

According to the battery module thus configured, a sliding movement of the first cover body and the second cover body along the first direction due to thermal expansion and thermal contraction is permitted while the positions of the first cover body and the second cover body with respect to the attachment-target portion are kept at both ends in the first direction. Thus, the states of attachment of the first cover body and the second cover body can be more securely maintained while preventing positional displacement of each of the first cover body and the second cover body with respect to the plurality of battery cells.

[3] The battery module according to [1] or [2], wherein a total length of the first cover body in the first direction is larger than a total length of the second cover body in the first direction, and the retainer is provided at a central position of a total length of the plurality of battery cells in the first direction.

According to the battery module thus configured, since the total length of the first cover body in the first direction is larger than the total length of the second cover body in the first direction, the retainer can be provided at the central position of the total length of the plurality of battery cells in the first direction. By providing the retainer at the central position of the total length of the plurality of battery cells in the first direction, the retainer can more efficiently contribute to improvement of rigidity of the battery module.

[4] The battery module according to any one of [1] to [3], wherein the first cover body is provided with a groove portion recessed in the second direction and extending in the third direction, and the retainer is disposed in the groove portion.

According to the battery module thus configured, positional displacement of the retainer with respect to the first cover body can be prevented.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing a battery module according to an embodiment of the present invention.

FIG. 2 is another perspective view showing the battery module according to the embodiment of the present invention.

FIG. 3 is an exploded assembly diagram showing the battery module in FIG. 1.

FIG. 4 is a perspective view showing an internal structure of the battery module in FIG. 1.

FIG. 5 is a perspective view showing a battery cell unit included in the battery module in FIG. 1.

FIG. 6 is a perspective view showing a battery cell included in the battery cell unit in FIG. 1.

FIG. 7 is a perspective view showing a first cover body.

FIG. 8 is another perspective view showing the first cover body.

FIG. 9 is a perspective view showing a second cover body.

FIG. 10 is another perspective view showing the second cover body.

FIG. 11 is a cross sectional view showing the battery module when viewed in a direction of arrow on a line XI-XI in FIG. 1.

### DESCRIPTION OF THE PREFERRED EMBODIMENTS

Embodiments of the present invention will be described with reference to figures. It should be noted that in the figures referred to below, the same or corresponding members are denoted by the same reference characters.

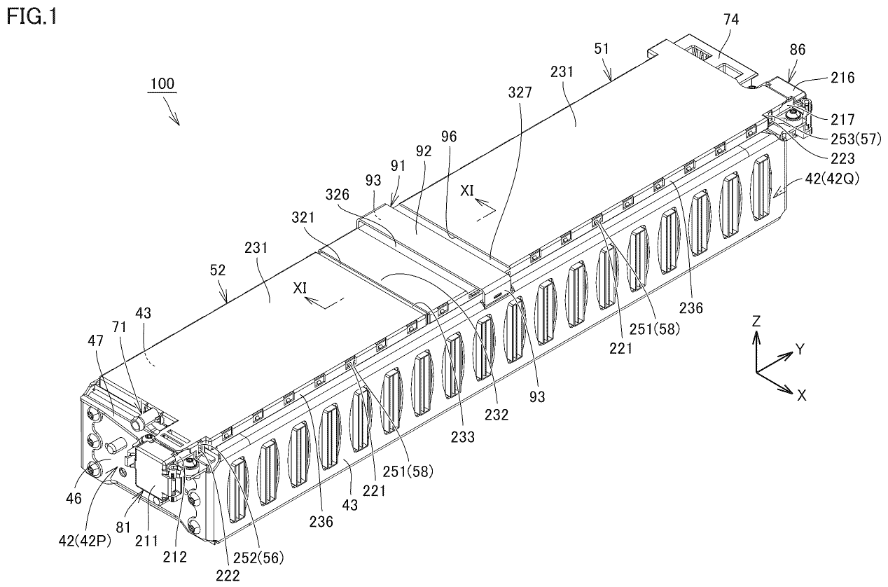

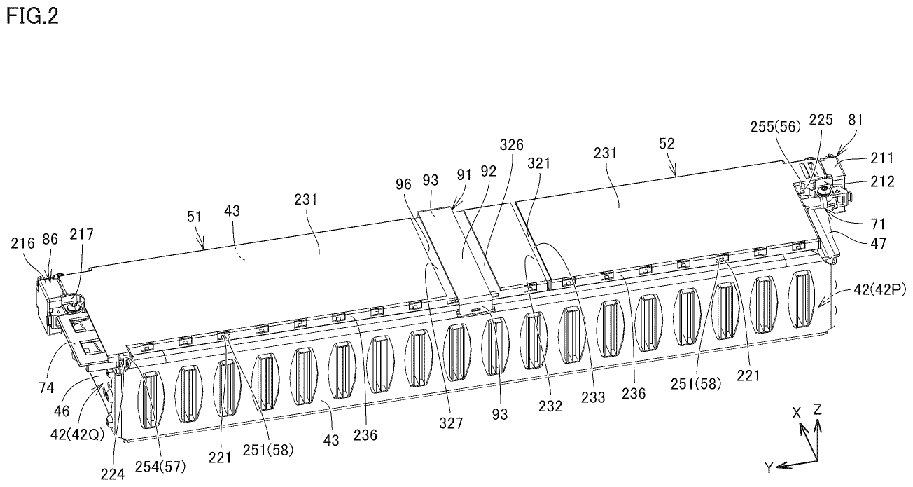

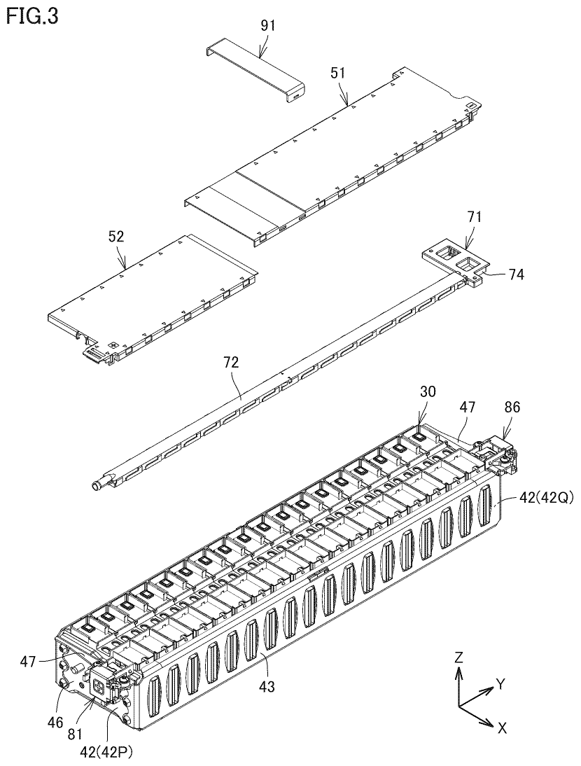

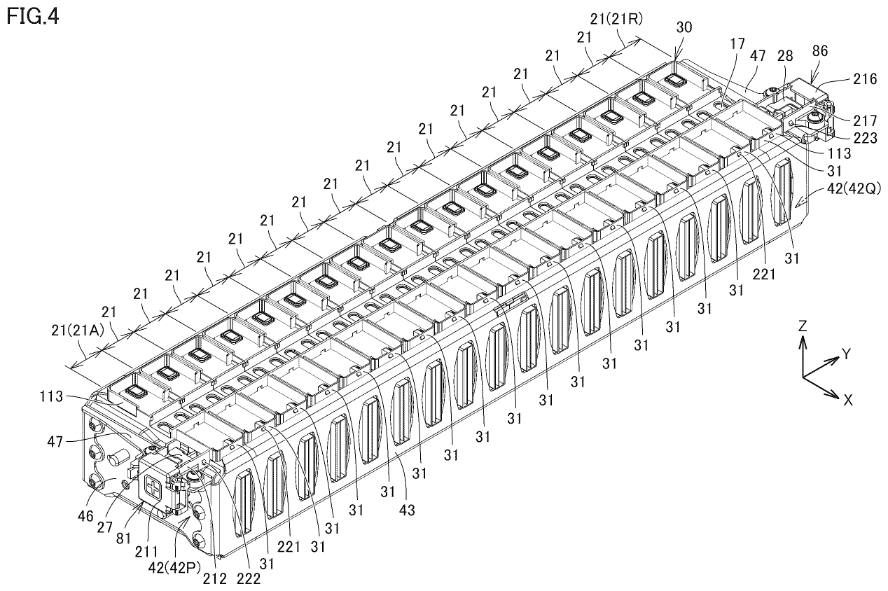

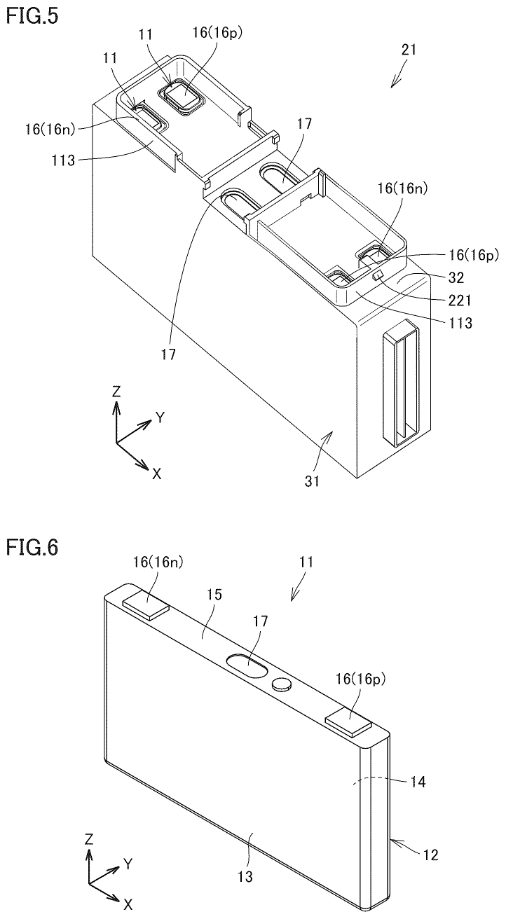

Each of FIGS. 1 and 2 is a perspective view showing a battery module according to an embodiment of the present invention. FIG. 3 is an exploded assembly diagram showing the battery module in FIG. 1. FIG. 4 is a perspective view showing an internal structure of the battery module in FIG. 1. FIG. 5 is a perspective view showing a battery cell unit included in the battery module in FIG. 1. FIG. 6 is a perspective view showing the battery cell included in the battery cell unit in FIG. 1.

Referring to FIGS. 1 to 6, a battery module 100 is used as a power supply for driving a vehicle such as a hybrid electric vehicle (HEV), a plug-in hybrid electric vehicle (PHEV), or a battery electric vehicle (BEV).

In the present specification, for convenience of description of the structure of battery module 100, the “Y axis” represents an axis extending in parallel with a stacking direction of a plurality of below-described battery cells 11, the “X axis” represents an axis extending in a direction orthogonal to the Y axis, and the “Z axis” represents an axis extending in a direction orthogonal to the Y axis and the X axis. An obliquely rightward upward direction in the plane of sheet of FIG. 1 is “+Y axis direction”, and an obliquely leftward downward direction in the plane of sheet of FIG. 1 is “−Y axis direction”. An obliquely rightward downward direction in the plane of sheet of FIG. 1 is “+X axis direction” and an obliquely leftward upward direction in the plane of sheet of FIG. 1 is “−X axis direction”. An upward direction in the plane of sheet of FIG. 1 is “+Z axis direction” and a downward direction in the plane of sheet of FIG. 1 is “−Z axis direction”. Typically, battery module 100 is mounted on a vehicle in such a posture that the +Z axis direction corresponds to the upward direction and the −Z axis direction corresponds to the downward direction.

First, an overall structure of battery module 100 will be described. As shown in FIG. 4, battery module 100 has a plurality of battery cell units 21. The plurality of battery cell units 21 are arranged side by side in the Y axis direction. A battery cell unit 21A is disposed at an end portion in the −Y axis direction, and a battery cell unit 21R is disposed at an end portion in the +Y axis direction.

It should be noted that the number of battery cell units 21 included in battery module 100 is not particularly limited as long as two or more battery cell units 21 are included.

As shown in FIGS. 5 and 6, each of battery cell units 21 has a plurality of battery cells 11 and a case body 31.

In each battery cell unit 21, two battery cells 11 are arranged side by side continuously in the Y axis direction. It should be noted that the number of battery cells 11 included in each battery cell unit 21 is not particularly limited as long as a plurality of battery cells 11 are included.

Each of battery cells 11 is a lithium ion battery. Battery cell 11 has an output density of 8000 W/L or more. Battery cell 11 has a prismatic shape and has a thin plate shape in the form of a rectangular parallelepiped. The plurality of battery cells 11 are stacked such that the Y axis direction corresponds to the thickness direction of each battery cell 11.

Each of battery cells 11 has an exterior package 12. Exterior package 12 is constituted of a housing having a rectangular parallelepiped shape, and forms the external appearance of battery cell 11. An electrode assembly and an electrolyte solution are accommodated in exterior package 12.

Exterior package 12 has a cell side surface 13, a cell side surface 14, and a cell top surface 15. Each of cell side surface 13 and cell side surface 14 is constituted of a flat surface orthogonal to the Y axis direction. Cell side surface 13 and cell side surface 14 are oriented oppositely in the Y axis direction. Each of cell side surface 13 and cell side surface 14 has the largest area among the areas of the plurality of side surfaces of exterior package 12. Cell top surface 15 is constituted of a flat surface orthogonal to the Z axis direction. Cell top surface 15 is oriented in the +Z axis direction.

Battery cell 11 further has a gas-discharge valve 17. Gas-discharge valve 17 is provided in cell top surface 15. Gas-discharge valve 17 is provided at the center portion of cell top surface 15 in the X axis direction. When internal pressure of exterior package 12 becomes more than or equal to a predetermined value due to gas generated inside exterior package 12, gas-discharge valve 17 discharges the gas to the outside of exterior package 12. The gas from gas-discharge valve 17 flows through a below-described duct 71 and is discharged to the outside of battery module 100.

Battery cell 11 further has electrode terminals 16 that are a pair of a positive electrode terminal 16p and a negative electrode terminal 16n. Electrode terminals 16 are provided on cell top surface 15. Positive electrode terminal 16p and negative electrode terminal 16n are provided on both sides with gas-discharge valve 17 being interposed therebetween in the X axis direction.

Case body 31 has a rectangular parallelepiped appearance. Case body 31 is composed of a resin. In each battery cell unit 21, case body 31 accommodates a plurality of battery cells 11. Case body 31 has a case top portion 32. Case top portion 32 has a wall shape having a thickness direction corresponding to the Z axis direction with case top portion 32 being disposed in parallel with the X-Y axes plane.

As shown in FIG. 4, the plurality of battery cells 11 are stacked in the Y axis direction across battery cell units 21 arranged side by side in the Y axis direction. The plurality of battery cells 11 are stacked such that cell side surfaces 13 of battery cells 11 adjacent to each other in the Y axis direction face each other and cell side surfaces 14 of battery cells 11 adjacent to each other in the Y axis direction face each other. Thus, positive electrode terminals 16p and negative electrode terminals 16n are alternately arranged in the Y axis direction in which the plurality of battery cells 11 are stacked. Positive electrode terminal 16p and negative electrode terminal 16n adjacent to each other in the Y axis direction are connected to each other by a bus bar (not shown). Thus, the plurality of battery cells 11 are electrically connected together in series.

As shown in FIGS. 1 to 4, battery module 100 further has a pair of end plates 42 (42P, 42Q) and a pair of binding bars 43. The pair of binding bars 43 and the pair of end plates 42 collectively hold the plurality of battery cell units 21 (the plurality of battery cells 11) arranged side by side in the Y axis direction.

The pair of end plates 42 are disposed at both ends beside the plurality of battery cells 11 (the plurality of battery cell units 21) in the Y axis direction. End plate 42P faces battery cell unit 21A in the Y axis direction, and end plate 42Q faces battery cell unit 21R in the Y axis direction.

Each of end plates 42 has a plate portion 46 and a roof portion 47. Plate portion 46 has a plate shape having a thickness direction corresponding to the Y axis direction. Roof portion 47 extends, from an end portion (upper end portion) of plate portion 46 in the +Z axis direction, in a direction away from the stack of battery cells 11 in the Y axis direction. Roof portion 47 has a roof shape having a thickness in the Z axis direction and extending in the form of a strip along the upper end portion of plate portion 46.

The pair of binding bars 43 are disposed at both ends of the stack of battery cells 11 in the X axis direction. Each of binding bars 43 extends in the Y axis direction. An end portion of binding bar 43 in the −Y axis direction is connected to end plate 42P. An end portion of binding bar 43 in the +Y axis direction is connected to end plate 42Q. The pair of binding bars 43 and the pair of end plates 42 apply a restraint force in the Y axis direction onto the plurality of battery cells 11 (the plurality of battery cell units 21).

Battery module 100 further has a positive terminal box 81 and a negative terminal box 86. Each of positive terminal box 81 and negative terminal box 86 is composed of a resin. Positive terminal box 81 and negative terminal box 86 respectively accommodate a positive collective terminal and a negative collective terminal each for connecting battery module 100 to an external wiring such as a cable disposed outside battery module 100.

As shown in FIG. 4, positive terminal box 81 has a base 212 and an openable/closable door 211. Base 212 is attached to end plate 42 (42P). Base 212 is provided over roof portion 47 in the Y axis direction. A bus bar 27 extending from battery cell 11 toward the positive collective terminal is mounted on base 212. Openable/closable door 211 is attached to base 212 so as to be openable and closable. Negative terminal box 86 has a base 217 and an openable/closable door 216. Base 217 and openable/closable door 216 correspond to base 212 and openable/closable door 211 in positive terminal box 81, respectively. A bus bar 28 extending from battery cell 11 toward the negative collective terminal is mounted on base 217.

Battery module 100 further has a duct 71. Duct 71 is composed of a resin. Duct 71 extends in the Y axis direction with duct 71 facing the plurality of battery cells 11 (the plurality of battery cell units 21) in the Z axis direction. Duct 71 forms a path through which gas discharged from each of the plurality of battery cells 11 flows. Duct 71 is attached to a plurality of case bodies 31.

As shown in FIG. 3, duct 71 has a duct main body portion 72 and a connector supporting portion 74. Duct main body portion 72 forms a main part of duct 71 for allowing gas from each battery cell 11 to flow therethrough. Duct main body portion 72 extends in the Y axis direction with duct main body portion 72 facing, in the Z axis direction, the plurality of gas-discharge valves 17 arranged side by side with a space being interposed therebetween in the Y axis direction. Connector supporting portion 74 extends in the +Y axis direction from the end portion of duct main body portion 72 in the +Y axis direction. Connector supporting portion 74 has a shape of plate disposed in parallel with the X-Y axes plane.

Battery module 100 further has a first cover body 51, a second cover body 52, and a retainer 91.

Each of first cover body 51 and second cover body 52 is composed of a resin. First cover body 51 and second cover body 52 are provided to cover the plurality of battery cells 11 in the Z axis direction. Each of first cover body 51 and second cover body 52 is provided to face case top portions 32 of case bodies 31 in the Z axis direction. Each of first cover body 51 and second cover body 52 is provided to further cover bus bars 27, 28 and duct 71.

Each of first cover body 51 and second cover body 52 is disposed in parallel with the X-Y axes plane. First cover body 51 and second cover body 52 are arranged side by side in the Y axis direction (stacking direction of battery cells 11). First cover body 51 is disposed on the positive side in the Y axis direction, and second cover body 52 is disposed on the negative side in the Y axis direction.

First cover body 51 and second cover body 52 are detachably attached to the plurality of case bodies 31, base 212, base 217, and duct 71. The plurality of case bodies 31, base 212, base 217, and duct 71 constitute an attachment-target member 30 to which first cover body 51 and second cover body 52 are attached.

Retainer 91 is composed of a metal. Retainer 91 extends in the X axis direction. Retainer 91 is connected to the pair of binding bars 43 at its both ends in the X axis direction. Retainer 91 is provided at a central position of the total length of the plurality of battery cells 11 in the Y axis direction. That is, a length between end plate 42P and retainer 91 in the Y axis direction is the same as a length between retainer 91 and end plate 42Q in the Y axis direction.

Retainer 91 has a bar portion 92 and a pair of bent portions 93. Bar portion 92 is constituted of a flat plate that has a thickness direction corresponding to the Z axis direction and that is disposed in parallel with the X-Y axes plane. Bar portion 92 extends in the form of a strip in the X axis direction as its long side direction with an unchanged width in the Y axis direction. Each of the pair of bent portions 93 is bent at 90° from a corresponding one of the both ends of bar portion 92 in the X axis direction and extends in the −Z axis direction. The pair of bent portions 93 are respectively connected to the pair of binding bars 43 by an engagement structure constituted of a combination of claw portions and openings.

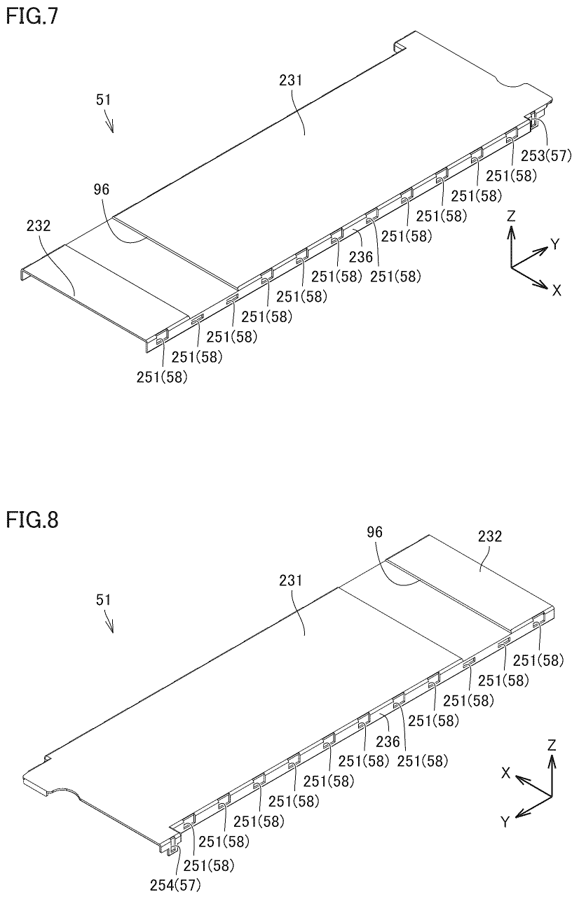

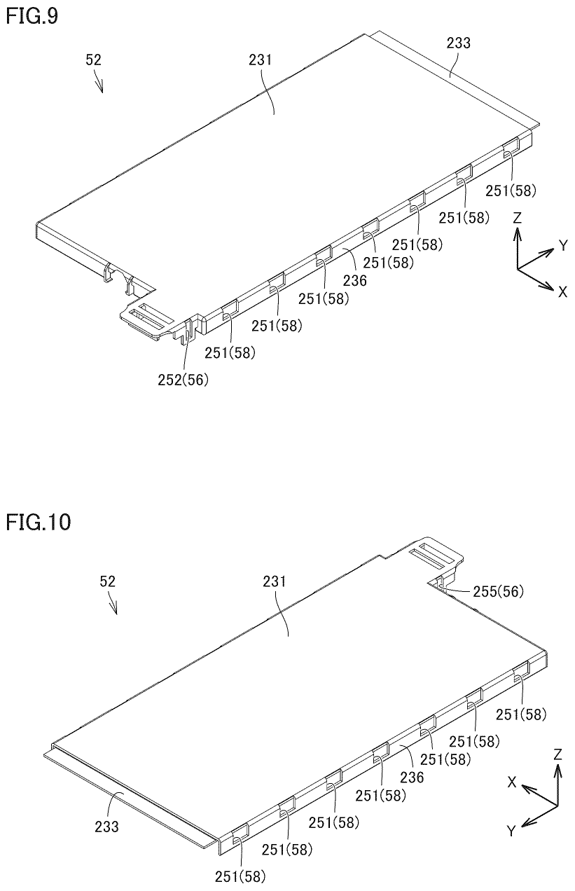

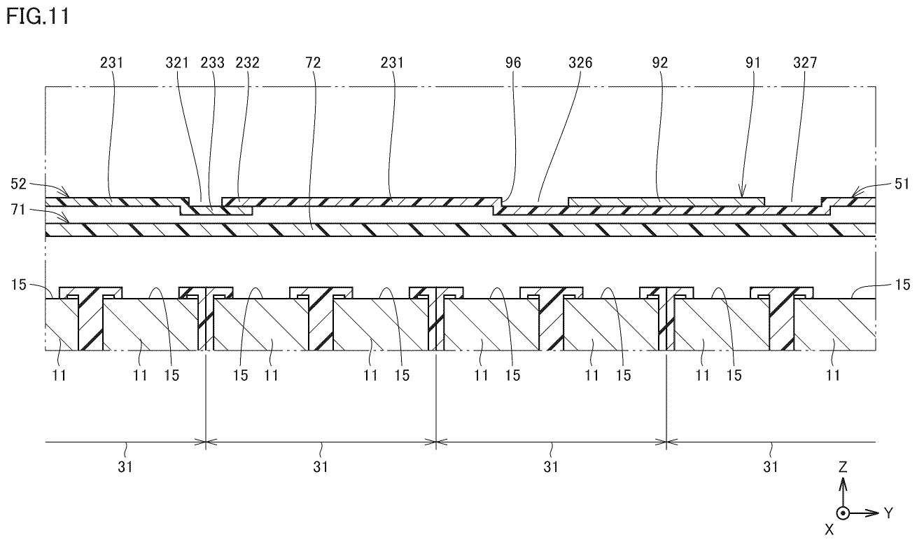

Each of FIGS. 7 and 8 is a perspective view showing the first cover body. Each of FIGS. 9 and 10 is a perspective view showing the second cover body. FIG. 11 is a cross sectional view of the battery module when viewed in a direction of arrow on a line XI-XI in FIG. 1. Next, a structure of each of first cover body 51 and second cover body 52 will be described more specifically.

Referring to FIGS. 1 to 3 as well as FIGS. 7 to 11, each of first cover body 51 and second cover body 52 has a flat plate portion 231 and edge portions 236. Flat plate portion 231 has a thickness in the Z axis direction and is disposed in parallel with the X-Y axes plane. Flat plate portion 231 has, as a whole, a quadrangular shape in which the Y axis direction corresponds to the long side direction and the X axis direction corresponds to the short side direction when viewed in a plan view. Flat plate portion 231 is provided to face the plurality of battery cells 11 (the plurality of battery cell units 21) in the Z axis direction. Each of edge portions 236 extends in the −Z axis direction from a peripheral edge portion of flat plate portion 231. Edge portion 236 has a height in the Z axis direction and intermittently extends along the peripheral edge portion of flat plate portion 231.

The total length of (flat plate portion 231 of) first cover body 51 in the Y axis direction is larger than the total length of (flat plate portion 231 of) second cover body 52 in the Y axis direction.

As shown in FIGS. 7 and 8, first cover body 51 has a first overlapping portion 232. First overlapping portion 232 is provided along an end portion of flat plate portion 231 of first cover body 51 in the −Y axis direction. First overlapping portion 232 corresponds to a portion of flat plate portion 231 extending in the form of a strip in the X axis direction with an unchanged width in the Y axis direction.

First cover body 51 is provided with a groove portion 96. Groove portion 96 is provided in flat plate portion 231 of first cover body 51. Groove portion 96 has a groove shape that has a height direction corresponding to the Z axis direction and that extends in the X axis direction. Groove portion 96 has a groove shape that is recessed from a surface of flat plate portion 231 oriented in the +Z axis direction and that extends in the X axis direction with an unchanged width in the Y axis direction. The width of groove portion 96 in the Y axis direction is larger than the width of retainer 91 (bar portion 92) in the Y axis direction.

As shown in FIGS. 9 and 10, second cover body 52 has a second overlapping portion 233. Second overlapping portion 233 is provided along an end portion of flat plate portion 231 of second cover body 52 in the +Y axis direction. Second overlapping portion 233 corresponds to a stepped portion that extends in the form of a strip in the X axis direction with an unchanged width in the Y axis direction and that forms a step in the −Z axis direction with respect to flat plate portion 231 by the thickness of flat plate portion 231.

Referring to FIGS. 1 to 3 as well as FIG. 11, second overlapping portion 233 overlaps with first overlapping portion 232. Second overlapping portion 233 is disposed between each battery cell 11 and first overlapping portion 232 in the Z axis direction. First overlapping portion 232 is disposed on the positive side in the Z axis direction to overlap with second overlapping portion 233. First cover body 51 is disposed between each battery cell 11 and retainer 91 (bar portion 92) in the Z axis direction. Retainer 91 (bar portion 92) is disposed on the positive side in the Z axis direction to overlap with first cover body 51.

As shown in FIG. 11, first overlapping portion 232 and second overlapping portion 233 are in surface contact with each other in a plane parallel to the X-Y axes plane. A clearance 321 is provided between flat plate portion 231 of second cover body 52 and first overlapping portion 232 of first cover body 51 in the Y axis direction.

Retainer 91 (bar portion 92) is disposed in groove portion 96. A clearance 326 is provided between an end portion of retainer 91 in the −Y axis direction and a groove wall of groove portion 96 formed by flat plate portion 231 of first cover body 51. A clearance 327 is provided between an end portion of retainer 91 in the +Y axis direction and a groove wall of groove portion 96 formed by flat plate portion 231 of first cover body 51.

As shown in FIG. 3, when assembling battery module 100, second cover body 52, first cover body 51, and retainer 91 are assembled in this order to attachment-target member 30 and the pair of binding bars 43.

Next, a structure for attaching each of first cover body 51 and second cover body 52 to attachment-target member 30 will be described.

Referring to FIGS. 1 and 2 as well as FIGS. 7 to 10, first cover body 51 has first connection portions 57. Second cover body 52 has second connection portions 56. At least one of first cover body 51 and second cover body 52 has third connection portions 58.

Each of first connection portions 57 is disposed opposite to second cover body 52 with respect to first overlapping portion 232 in the Y axis direction. First connection portion 57 is provided at an end portion of first cover body 51 in the +Y axis direction. First connection portion 57 is connected to attachment-target member 30 so as to be fixed in the Y axis direction. Each of second connection portions 56 is disposed opposite to first cover body 51 with respect to second overlapping portion 233 in the Y axis direction. Second connection portion 56 is provided at an end portion of second cover body 52 in the −Y axis direction. Second connection portion 56 is connected to attachment-target member 30 so as to be fixed in the Y axis direction.

Each of third connection portions 58 is disposed between first connection portion 57 and second connection portion 56 in the Y axis direction. Third connection portions 58 are provided in first cover body 51 and second cover body 52. Each of third connection portions 58 is connected to attachment-target member 30 so as to be slidable in the Y axis direction.

Referring to FIGS. 1 to 5, each of case bodies 31 further has rib portions 113 and claw portions 221.

Each of rib portions 113 extends in the form of a rib so as to protrude from case top portion 32 and surround electrode terminals 16 with rib portion 113 having a height in the Z axis direction. Each of claw portions 221 has a protruding shape protruding in the X axis direction from a side surface of a corresponding one of rib portions 113. Claw portions 221 are provided in an outer side surface of rib portion 113 oriented in the +X axis direction and an outer side surface of rib portion 113 oriented in the −X axis direction. Claw portion 221 has a protruding shape protruding in the +X axis direction in the outer surface of rib portion 113 oriented in the +X axis direction, and claw portion 221 has a protruding shape protruding in the −X axis direction in the outer surface of rib portion 113 oriented in the −X axis direction. In a state in which the plurality of case bodies 31 are arranged side by side in the Y axis direction, the plurality of claw portions 221 are provided with a space being interposed therebetween in the Y axis direction.

Referring to FIGS. 1 to 4, base 212 is provided with a claw portion 222 and a claw portion 225. Claw portion 222 is provided in an outer surface of base 212 oriented in the +X axis direction, and has a protruding shape protruding in the +X axis direction. Claw portion 225 is provided in an outer surface of base 212 oriented in the −X axis direction, and has a protruding shape protruding in the −X axis direction. Each of claw portion 222 and claw portion 225 is provided just above end plate 42P. Base 217 is provided with a claw portion 223. Claw portion 223 is provided in an outer surface of base 217 oriented in the +X axis direction, and has a protruding shape protruding in the +X axis direction. Claw portion 223 is provided just above end plate 42Q.

Connector supporting portion 74 of duct 71 is provided with a claw portion 224. Claw portion 224 is provided in an outer surface of connector supporting portion 74 oriented in the −X axis direction, and has a protruding shape protruding in the −X axis direction. Claw portion 224 is provided just above end plate 42Q.

Referring to FIGS. 1 and 2 as well as FIGS. 7 to 10, first cover body 51 is provided with a plurality of openings 251, an opening 253, and an opening 254. Second cover body 52 is provided with a plurality of openings 251, an opening 252, and an opening 255. The plurality of openings 251, opening 252, opening 253, opening 254 and opening 255 are provided in edge portion 236.

As shown in FIGS. 1 and 2 as well as FIGS. 7 and 8, opening 253 is provided in a portion of first cover body 51 that covers base 217. Opening 254 is provided in a portion of first cover body 51 that covers connector supporting portion 74. Claw portion 223 and claw portion 224 are fitted to opening 253 and opening 254, respectively. An opening length (width) of opening 253 in the Y axis direction is substantially the same as a length (width) of claw portion 223 in the Y axis direction, and an opening length (width) of opening 254 in the Y axis direction is substantially the same as a length (width) of claw portion 224 in the Y axis direction. Claw portion 223 and claw portion 224 are anchored inside opening 253 and opening 254, respectively, in the Z axis direction and the Y axis direction. With such a configuration, opening 253 and opening 254 constitute first connection portions 57 each connected to attachment-target member 30 (base 217 and connector supporting portion 74) so as to be fixed in the Y axis direction.

As shown in FIGS. 1 and 2 as well as FIGS. 9 and 10, each of opening 252 and opening 255 is provided in a portion of second cover body 52 that covers base 212. Claw portion 222 and claw portion 225 are fitted to opening 252 and opening 255, respectively. An opening length (width) of opening 252 in the Y axis direction is substantially the same as a length (width) of claw portion 222 in the Y axis direction, and an opening length (width) of opening 255 in the Y axis direction is substantially the same as a length (width) of claw portion 225 in the Y axis direction. Claw portion 222 and claw portion 225 are anchored inside opening 252 and opening 255, respectively, in the Z axis direction and the Y axis direction. With such a configuration, opening 252 and opening 255 constitute second connection portions 56 each connected to attachment-target member 30 (base 212) so as to be fixed in the Y axis direction.

As shown in FIGS. 1 and 2 as well as FIGS. 7 and 8, first cover body 51 is further provided with the plurality of openings 251. The plurality of openings 251 are arranged side by side with a space being interposed therebetween in the Y axis direction. The plurality of openings 251 are disposed between each of opening 253 and opening 254 (first connection portion 57) and first overlapping portion 232 in the Y axis direction.

As shown in FIGS. 1 and 2 as well as FIGS. 9 and 10, second cover body 52 is further provided with the plurality of openings 251. The plurality of openings 251 are arranged side by side with a space being interposed therebetween in the Y axis direction. The plurality of openings 251 are disposed between each of opening 252 and opening 255 (second connection portion 56) and second overlapping portion 233 in the Y axis direction.

As shown in FIGS. 1 and 2, the plurality of claw portions 221 are fitted to the plurality of openings 251, respectively. An opening length (width) of each opening 251 in the Y axis direction is larger than a length (width) of each claw portion 221 in the Y axis direction. Claw portions 221 are disposed at positions away from the opening edges of openings 251 in the ±Y axis directions. Claw portions 221 are anchored only in the Z axis direction inside openings 251. With such a configuration, the plurality of openings 251 constitute third connection portions 58 each connected to attachment-target member 30 (the plurality of case bodies 31) so as to be slidable in the Y axis direction.

Referring to FIGS. 1, 2 and 11, in battery module 100 according to the present embodiment, in response to expansion and contraction of each of first cover body 51 and second cover body 52 due to a temperature change, first overlapping portion 232 and second overlapping portion 233 are slid relative to each other in the Y axis direction with first overlapping portion 232 and second overlapping portion 233 overlapping with each other in the Z axis direction. Thus, a clearance can be prevented from being formed between first cover body 51 and second cover body 52, thereby securing an insulation distance for each battery cell 11.

Second overlapping portion 233 of second cover body 52 is disposed between each battery cell 11 and first overlapping portion 232 of first cover body 51, and first cover body 51 is disposed between each battery cell 11 and retainer 91. Therefore, first overlapping portion 232 of first cover body 51 functions as a fixture for fastening second cover body 52 to attachment-target member 30, and retainer 91 functions as a fixture for fastening first cover body 51 to attachment-target member 30. Thus, each of first cover body 51 and second cover body 52 can be securely prevented from falling off from attachment-target member 30.

In the present embodiment, since retainer 91 is disposed in groove portion 96 provided in first cover body 51, positional displacement of retainer 91 with respect to first cover body 51 can be prevented.

Further, clearance 321 is provided between flat plate portion 231 of second cover body 52 and first overlapping portion 232, and each of clearance 326 and clearance 327 is provided between retainer 91 and the groove wall of groove portion 96 formed by flat plate portion 231 of first cover body 51. With such a configuration, first cover body 51 and second cover body 52 can be prevented from interfering with each other in response to a sliding movement of each of first cover body 51 and second cover body 52 in the Y axis direction, and first cover body 51 and retainer 91 can be prevented from interfering with each other in response to the sliding movement of each of first cover body 51 and second cover body 52 in the Y axis direction.

Further, since the total length of first cover body 51 in the Y axis direction is larger than the total length of second cover body 52 in the Y axis direction, retainer 91 overlapping with first cover body 51 in the Z axis direction can be provided at the central position of the total length of the plurality of battery cells 11 in the Y axis direction. Thus, retainer 91 can more efficiently contribute to improvement of rigidity of battery module 100.

Further, each of first connection portion 57 and second connection portion 56 is connected to attachment-target member 30 (base 212, base 217, and connector supporting portion 74) so as to be fixed in the Y axis direction, whereas third connection portion 58 disposed between first connection portion 57 and second connection portion 56 is connected to attachment-target member 30 (the plurality of case bodies 31) so as to be slidable in the Y axis direction. With such a configuration, a sliding movement of each of first cover body 51 and second cover body 52 along the Y axis direction in response to expansion and contraction of each of first cover body 51 and second cover body 52 is permitted while the positions of first cover body 51 and second cover body 52 are kept at the both ends in the Y axis direction. Thus, positional displacement of each of first cover body 51 and second cover body 52 with respect to the plurality of battery cells 11 can be prevented, and deformation of each of first cover body 51 and second cover body 52 or impairment of the state of attachment of each of first cover body 51 and second cover body 52 to attachment-target member 30 can be prevented.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A battery module comprising:
a plurality of battery cells stacked in a first direction;
a first cover body and a second cover body arranged side by side in the first direction and provided to cover the plurality of battery cells in a second direction orthogonal to the first direction;
an attachment-target member to which the first cover body and the second cover body are attached;
a pair of binding bars extending, in the first direction, on both sides beside the plurality of battery cells in a third direction orthogonal to the first direction and the second direction, the pair of binding bars restraining the plurality of battery cells in the first direction; and
a retainer extending in the third direction and connected to the pair of binding bars, wherein
the first cover body has a first overlapping portion,
the second cover body has a second overlapping portion disposed between each of the battery cells and the first overlapping portion and overlapping with the first overlapping portion in the second direction, and
the first cover body is disposed between each of the battery cells and the retainer in the second direction.

2. The battery module according to claim 1, wherein
the first cover body has a first connection portion disposed opposite to the second cover body with respect to the first overlapping portion in the first direction, the first connection portion being connected to the attachment-target member so as to be fixed in the first direction,
the second cover body has a second connection portion disposed opposite to the first cover body with respect to the second overlapping portion in the first direction, the second connection portion being connected to the attachment-target member so as to be fixed in the first direction, and
at least one of the first cover body and the second cover body further has a third connection portion disposed between the first connection portion and the second connection portion in the first direction, the third connection portion being connected to the attachment-target member so as to be slidable in the first direction.

3. The battery module according to claim 1, wherein
a total length of the first cover body in the first direction is larger than a total length of the second cover body in the first direction, and
the retainer is provided at a central position of a total length of the plurality of battery cells in the first direction.

4. The battery module according to claim 1, wherein
the first cover body is provided with a groove portion recessed in the second direction and extending in the third direction, and
the retainer is disposed in the groove portion.
